(19) United States
(12) Patent Application Publication
(10) Pub. No.: US 2024/0267223 A1
(43) Pub. Date: Aug. 8, 2024

(54) IMAGE ANALYSIS SERVER, IMAGE ANALYSIS SYSTEM, IMAGE ANALYSIS METHOD, AND NON-TRANSITORY COMPUTER READABLE MEDIUM

(71) Applicant: NEC Corporation, Minato-ku, Tokyo (JP)

(72) Inventor: Yuto Suzuki, Tokyo (JP)

(73) Assignee: NEC Corporation, Minato-ku, Tokyo (JP)

(21) Appl. No.: 18/565,208

(22) PCT Filed: Jun. 4, 2021
(86) PCT No.: PCT/JP2021/021323

§ 371 Date: Nov. 29, 2023

(51) Int. Cl. H04L 9/32; G06V 10/70

(52) U.S. Cl. CPC H04L 9/32; G06V 10/70

(57) ABSTRACT

An image analysis server (200) includes personal information analysis means (300) for determining whether an image analysis target image contains personal information, encryption means (301) for encrypting the image analysis target image if it is determined that the image analysis target image contains the personal information, and storage means (302) for storing the image analysis target image encrypted by the encryption means. Thus, measures (security measures) can be taken to prevent the leakage of image analysis target images (images containing personal information such as names, phone numbers, and photos that can identify individuals).

### TECHNICAL FIELD

The present disclosure relates to an image analysis server, an image analysis system, an image analysis method, and a non-transitory computer readable medium.

### BACKGROUND ART

With regard to protecting personal information, a system for creating image data (scanned images) that excludes personal information (excluded by masking using a masking pattern) when personal information is contained in images is described in, for example, Patent Literature 1.

In contrast, the present inventor has studied countermeasures against the leakage of image analysis target images (images containing personal information such as names, telephone numbers, personally identifiable photographs, etc.) used in an image analysis system.

### CITATION LIST

### Patent Literature

Patent Literature 1: Japanese Unexamined Patent Application Publication No. 2017-085243

### SUMMARY OF INVENTION

### Technical Problem

However, Patent Literature 1 does not consider any measures to countermeasures against the leakage of image analysis target images (images containing personal information such as names, telephone numbers, personally identifiable photographs, etc.) used in an image analysis system.

In light of the abovementioned problem, an object of the present disclosure is to provide an image analysis server, an image analysis system, an image analysis method, and a non-transitory computer readable medium that can implement measures (security measures) against the leakage of image analysis target images (images containing personal information such as names, telephone numbers, personally identifiable photographs, etc.)

### Solution to Problem

An image analysis server according to the present disclosure includes: personal information analysis means for determining whether an image analysis target image contains personal information; encryption means for encrypting the image analysis target image if it is determined that the image analysis target image contains the personal information; and storage means for storing the image analysis target image encrypted by the encryption means.

An image analysis system according to the present disclosure includes: personal information analysis means for determining whether an image analysis target image contains personal information; encryption means for encrypting the image analysis target image if it is determined that the image analysis target image contains the personal information; and storage means for storing the image analysis target image encrypted by the encryption means.

An image analysis method according to the present disclosure includes: determining whether an image analysis target image contains personal information; encrypting the image analysis target image if it is determined that the image analysis target image contains the personal information; and storing the image analysis target image encrypted by the encryption means.

A non-transitory computer readable medium according to the present disclosure storing a program causes a computer to execute: determining whether an image analysis target image contains personal information; encrypting the image analysis target image if it is determined that the image analysis target image contains the personal information; and storing the image analysis target image encrypted by the encryption means.

### Advantageous Effects of Invention

According to the present disclosure, it is possible to provide an image analysis server, an image analysis system, an image analysis method, and a non-transitory computer readable medium that can implement measures (security measures) against the leakage of image analysis target images (images containing personal information such as names, phone numbers, and photos that can identify individuals).

### BRIEF DESCRIPTION OF DRAWINGS

FIG. 1 is a schematic configuration diagram of an image analysis server 200;

FIG. 2 is a flowchart of an example of an operation of the image analysis server 200;

FIG. 3 is a block diagram showing a configuration of an image analysis system 1 according to a second example embodiment;

FIG. 4 is a hardware configuration diagram of a user terminal 100 (image analysis server 200);

FIG. 5 is a flowchart of an operation example of the image analysis system 1;

FIG. 6 is a flowchart of a user input;

FIG. 7 is a flowchart for image encryption processing (Step S11);

FIG. 8 is a flowchart for image analysis target image extraction processing (Step S13);

FIG. 9A is an example of a whole table;

FIG. 9B is an example of a subset table;

FIG. 10 is a flowchart of secure computation necessity determination processing (Step S14);

FIG. 11 is a flowchart of image decryption processing (Step S15);

FIG. 12 is a flowchart of image analysis processing (Step S18);

FIG. 13 is a flowchart of analysis report output processing (Step S19);

FIG. 14 is an example of an analysis report; and

FIG. 15 is an illustration depicting encryption (decryption) of an image (image file).

### EXAMPLE EMBODIMENT

### First Example Embodiment

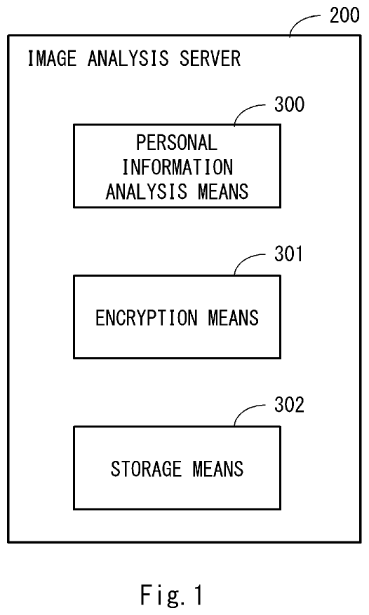

First, a configuration example of an image analysis server 200 according to a first example embodiment will be described with reference to FIG. 1.

FIG. 1 is a schematic configuration diagram of the image analysis server 200.

As shown in FIG. 1, the image analysis server 200 includes personal information analysis means 300 for determining whether an image analysis target image contains personal information, encryption means 301 for encrypting the image analysis target image when the image analysis target image contains personal information, and storage means 302 for storing the image analysis target image that has been encrypted by the encryption means 301. A personal information analysis unit 203 described later is an example of the personal information analysis means 300. An image file encryption unit 231 described later is an example of the encryption means 301. A storage unit 206 described later is an example of the storage means 302.

Next, an example of the operation of the image analysis server 200 will be described.

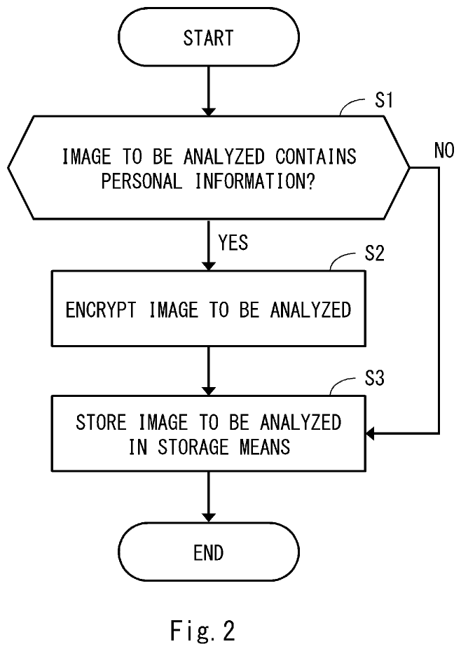

FIG. 2 is a flowchart of an example of the operation of the image analysis server 200.

First, the personal information analysis means 300 determines whether the image analysis target image contains personal information (Step S1). Next, when the image analysis target image contains personal information (Step S1: YES), the encryption means 301 encrypts the image analysis target image (Step S2). The encrypted image analysis target image is stored in the storage means 302 (Step S3). On the other hand, when it is determined that the image analysis target image does not contain personal information (Step S1: NO), the image analysis target image is stored in the storage means 302 without encryption (Step S3).

As described above, according to the first example embodiment, it is possible to implement measures (security measures) against leakage of image analysis target images (images containing personal information such as names, phone numbers, and photos that can identify individuals).

This is achieved by encrypting the image analysis target image when it is determined to contain personal information. In this way, by encrypting images containing personal information, even if these images were to leak or be exposed from the image analysis system 1, the personal information contained within them would remain encrypted. This serves to reduce the risk of personal information leakage, allowing for measures (security measures) to be in place to address such leaks.

### Second Example Embodiment

Hereinafter, the image analysis system 1 including the image analysis server 200 will be described in detail as a second example embodiment of the present disclosure.

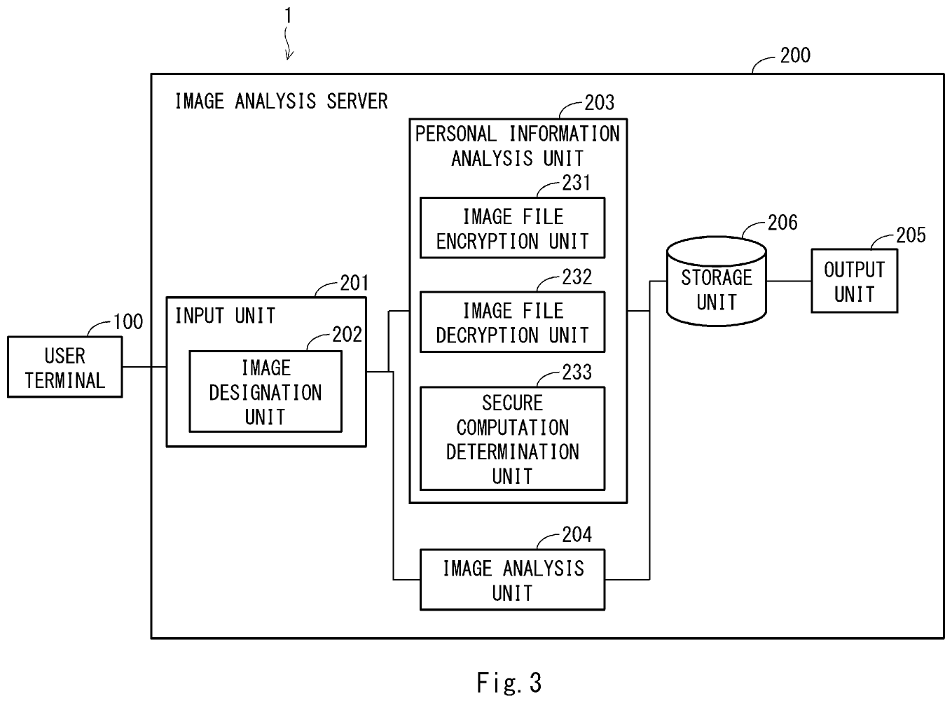

FIG. 3 is a block diagram showing a configuration of the image analysis system 1 according to the second example embodiment.

As shown in FIG. 3, the image analysis system 1 includes a user terminal 100 (client) and the image analysis server 200 to which the user terminal 100 (client) is connected via a communication line (e.g., the Internet).

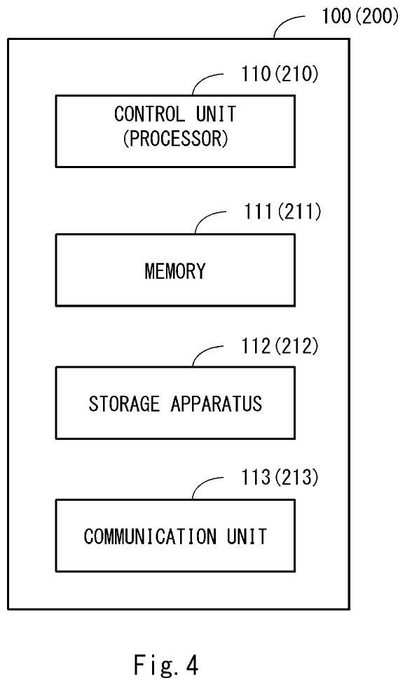

FIG. 4 is a hardware configuration diagram of the user terminal 100 (image analysis server 200).

As shown in FIG. 4, the user terminal 100 is a computer including a control unit 110, a memory 111, a storage apparatus 112, a communication unit 113, and so on. For example, the user terminal 100 is a personal computer, a smartphone, a tablet terminal, a smartwatch, or a mobile phone.

The user terminal 100 is mainly used for selecting (inputting) an image analysis target image, selecting (inputting) a method of image analysis, selecting (inputting) personal information, and inputting information related to image analysis.

The communication unit 113 is connected to the image analysis server 200 via a communication line (e.g., the Internet) and communicates with the image analysis server 200 via the communication line.

Like the user terminal 100, the image analysis server 200 is a computer (e.g., generic server with an OS installed) including a control unit 210, a memory 211, a storage apparatus 212, a communication unit 213, and so on (see FIG. 4). The image analysis server 200 may be a physical machine or a virtual machine.

The control unit 210 has a processor. The processor is, for example, a CPU (Central Processing Unit). The processor may be one or more. The processor functions as an input unit 201 (image designation unit 202), the personal information analysis unit 203 (image file encryption unit 231, image file decryption unit 232, secure computation determination unit 233), an image analysis unit 204, an output unit 205, and a storage unit 206 by executing predetermined programs read from the storage apparatus 212 into the memory 211 (e.g., RAM). Some or all of these components may be implemented in hardware.

The input unit 201 performs processing in which the user temporarily stores input contents (e.g., method of image analysis, personal information, and information related to image analysis) selected (input) by the user from the user terminal 100 within the image analysis server 200. The method of image analysis is, for example, a method of image analysis that the image analysis server 200 can execute, such as “face analysis”, “pose analysis”, or “vehicle analysis”. The personal information is information that the image analysis server 200 can extract, such as “name”, “phone number”, or “images that can identify individuals”. Information related to image analysis includes additional comments for image analysis, related information about the designated moving image (e.g., captured date and time, location, etc.), and information designating a part of the analysis target within the designated moving image (e.g., elapsed time from the beginning).

The image designation unit 202 performs processing in which the user temporarily stores the selected image analysis target image (e.g., the data designating the image) from the user terminal 100 within the image analysis server 200. The image analysis target image can be selected from images stored in the storage unit 206 or from images stored in devices such as the user terminal 100.

The personal information analysis unit 203 determines whether an image analysis target image contains personal information. The personal information analysis unit 203 (image file encryption unit 231) encrypts the image analysis target image. The personal information analysis unit 203 (image file decryption unit 232) decrypts the image analysis target image. The personal information analysis unit 203 (secure computation determination unit 233) determines whether secure computation is necessary for the image analysis target image.

The image analysis unit 204 performs image analysis on the image analysis target image by the method input by the user from the user terminal 100.

The output unit 205 prepares an analysis report based on the analysis result of the image analysis unit 204, and outputs the prepared analysis report.

For example, the output unit 205 outputs an analysis report generated based on a result of the image analysis by the image analysis unit 204. The analysis report includes at least one of the following items.

(1) A list of feature quantities extracted from the designated image. (2) A result of grouping feature quantities extracted from the designated image. For example, the number of groups and related information (representative feature quantity, representative images, etc.) of each group may be displayed. (3) An analysis result for each group (number of occurrences, time change of the number of occurrences, etc.).

Note that the image file analyzed by the image analysis unit 204 may be used as an image output to the analysis report.

The storage apparatus 212 is, for example, a read/write non-volatile storage unit such as a hard disk apparatus or an SSD. The storage apparatus 212 includes the storage unit 206.

The communication unit 213 is connected to the user terminal 100 via a communication line (e.g., the Internet), and communicates with the user terminal 100 via the communication line.

Next, an operation example of the image analysis system 1 having the above configuration will be described.

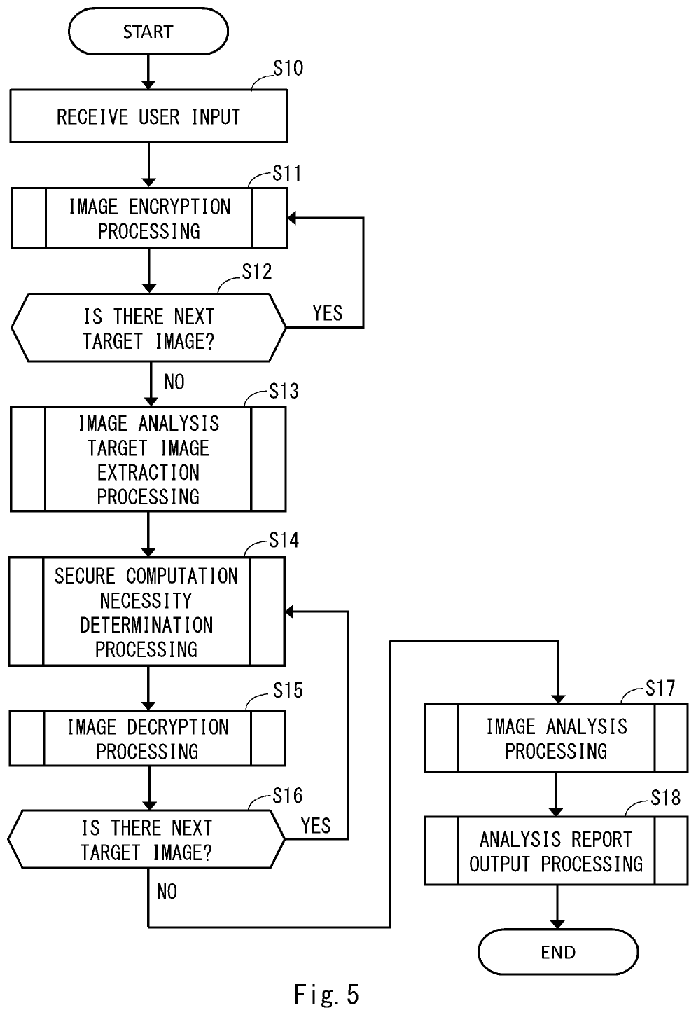

FIG. 5 is a flowchart of an operation example of the image analysis system 1. The processing shown in FIG. 5 is executed by the image analysis server 200.

First, a user input is received (Step S10). The user input is input from the user terminal 100, transmitted to the image analysis server 200 via the communication line, and received by the image analysis server 200 (temporarily stored in the image analysis server 200).

The user input will now be described.

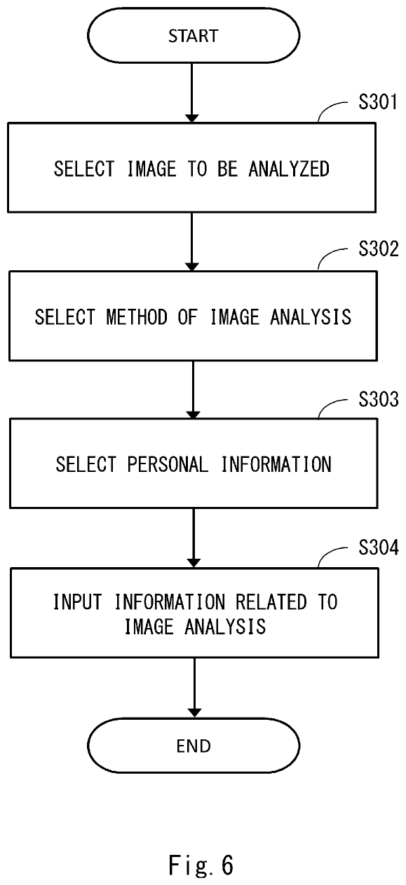

FIG. 6 is a flowchart of the user input. The processing of FIG. 6 is executed by the user terminal 100.

First, the user selects (inputs) an image analysis target image file as a user input, hereinafter referred to simply as an “image” (Step S301). For example, the user may select the image analysis target image from those stored in the storage unit 206. Additionally, the user may select the image analysis target image from those stored in the user terminal 100 or the like. In this case, the image selected by the user is transmitted to the image analysis server 200 via the communication line and stored in the storage unit 206. In response to this selection, the image analysis server 200 (input unit 201) receives the image selected by the user (Step S10). Then, the image analysis server 200 (image designation unit 202) designates the image analysis target image which has been selected by the user. Note that the image selected by the user may be a moving image or a still image. Furthermore, the user can select one or more images.

Next, the user selects (inputs) a method of image analysis as a user input (Step S302). For example, the user selects at least one of a plurality of types of a method of image analysis (e.g., “face analysis”, “pose analysis”, “vehicle analysis”) provided by the image analysis server 200 (input unit 201). In response to this selection, the image analysis server 200 (input unit 201) receives the method of image analysis selected by the user (Step S10). The received method of image analysis is used in image analysis processing (Step S18) described later.

Next, the user selects (inputs) personal information as a user input (Step S303). For example, the user selects at least one of a plurality of types of personal information (e.g., “name”, “phone number”, “images that can identify individuals”) provided from the image analysis server 200 (input unit 201). In response to this selection, the image analysis server 200 (input unit 201) receives the personal information selected by the user (Step S10). The input unit 201 is an example of personal information reception means according to the present disclosure. The received personal information is used in image encryption processing (Step S11) described later. The processing in Step S303 may be omitted, and the preset personal information may be used (instead of the personal information received in Step S10).

Next, the user inputs the information related to image analysis as a user input (Step S304). Information related to image analysis includes additional comments for image analysis, related information about the designated moving image (e.g., captured date and time, location, etc.), and information designating a part of the analysis target within the designated moving image (e.g., elapsed time from the beginning). In response to this input, the image analysis server 200 (input unit 201) receives the information related to image analysis input by the user (Step S10).

Next, returning to FIG. 5, the description is continued.

When the user input is received (Step S10), the image encryption processing is then executed (Step S11).

The image encryption processing (Step S11) will now be described.

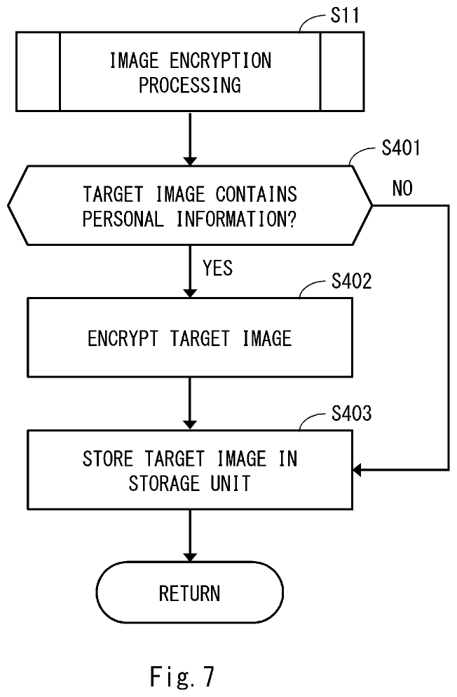

FIG. 7 is a flowchart of the image encryption processing (Step S11).

A target of the image encryption processing is the image received in Step S10. Hereinafter, the image is referred to as a target image.

Steps S401 to S403 below are executed (one by one) for each target image.

First, it is determined whether or not the target image contains personal information (personal information received in Step S10) (Step S401). This is done, for example, by the personal information analysis unit 203 extracting the feature quantity of the personal information from the target image. The personal information analysis unit 203 is called, for example, when an operation to input a new image is performed in the image designation unit 202.

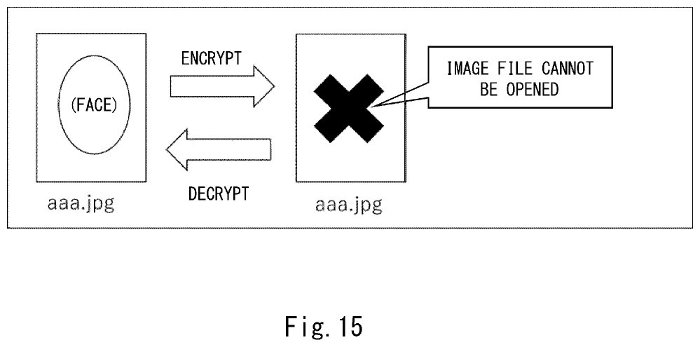

If it is determined that the personal information is contained as a result of the determination in Step S401 (Step S401: Yes), the target image is encrypted (Step S402). This is done, for example, by the image file encryption unit 231. FIG. 15 is an illustration depicting encryption (decryption) of an image (image file). By encrypting an image containing personal information in this way, even when the images were to leak or be exposed from the image analysis system 1, the risk of leakage of the personal information can be reduced, because the image (personal information contained in the image) is encrypted. In other words, security measures can be taken against leaks.

The target image encrypted in Step S402 is stored (saved) in the storage unit 206 (Step S403).

On the other hand, if it is determined that the target image does not contain personal information as a result of the determination in Step S401 (Step S401: No), the target image is saved in the storage unit 206 without being encrypted (Step S403).

Next, returning to FIG. 5, the description is continued.

If there is a next target image (YES in Step S12), that is, if the image encryption processing (Steps S401 to S403) has not been executed for all the images received in Step S10, the processing in Steps S401 to S403 is executed for the next target image.

On the other hand, if there is no next target image (YES in Step S12), that is, if the image encryption processing (Steps S401 to S403) has been executed for all the images received in Step S10, the image encryption processing is ended.

By executing the image encryption processing as described above, encrypted images and unencrypted images are accumulated in the storage unit 206.

When the image encryption processing is ended, the image analysis target image extraction processing is executed next (Step S13).

The image analysis target image extraction processing (Step S13) will now be described.

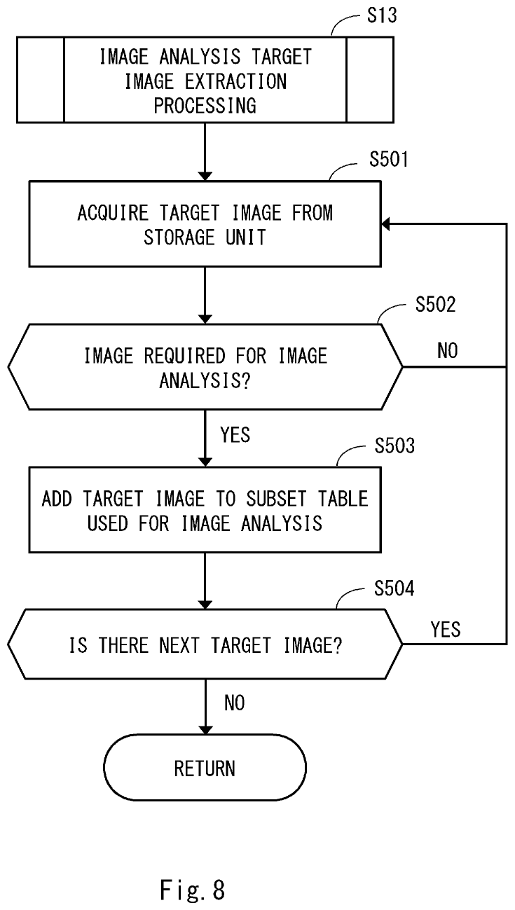

FIG. 8 is a flowchart of the image analysis target image extraction processing (Step S13). The processing shown in FIG. 8 is executed, for example, by the image analysis unit 204.

A target of the image analysis target image extraction processing is all the images stored in the storage unit 206. Hereinafter, these images are referred to as target images.

Steps S501 to S503 below are executed (one by one) for each target image.

First, the target image is acquired from the storage unit 206 (Step S501).

Next, it is determined whether or not the target image acquired in Step S501 is an image required for image analysis (Step S502). For example, if the target image matches the image designated by the user in the image designation unit 202, it is determined that the target image is an image (image file) required for image analysis. On the other hand, if the target image does not match the image designated by the user in the image designation unit 202, it is determined that the target image is an unnecessary image (image file) for image analysis.

If it is determined that the target image is an image required for image analysis as a result of the determination in Step S502 (Step S502: Yes), the target image is added to a subset table used for image analysis (Step S503).

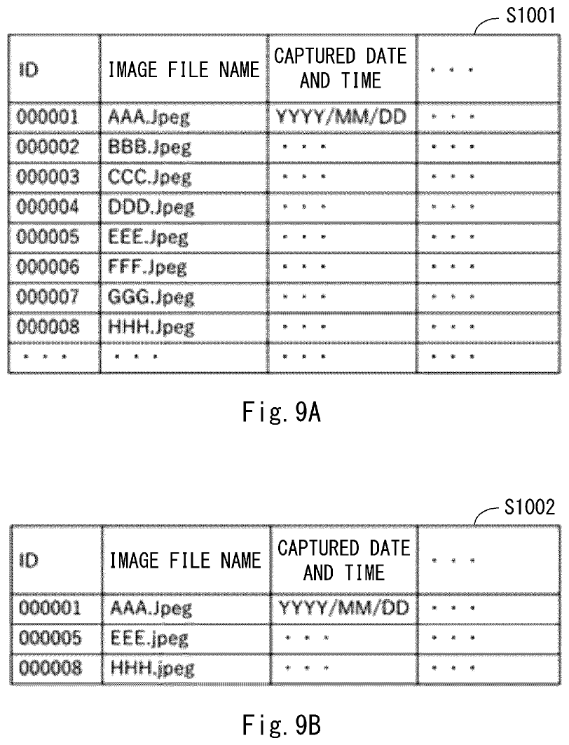

FIG. 9A shows an example of the whole table, and FIG. 9B shows an example of the subset table. As shown in FIG. 9B, the subset table refers to data S1002, which is extracted from all the data S1001 (see FIG. 9A) stored in the storage unit 206 and is necessary for analysis. By narrowing down a processing target (scanning target) to the data S1002 necessary for analysis, the processing speed is improved compared with that in the case where all the data S1001 is scanned.

Next, if there is a next target image (Step S504: YES), that is, if the image analysis target image extraction processing (Steps S501 to S503) has not been executed for all images stored in the storage unit 206, the next target image is acquired from the storage unit 206 (Step S501), and the processing of Steps S502 to S503 is executed for the next target image. Similarly, if it is determined that the image is unnecessary for image analysis as a result of the determination of Step S502 (Step S502: NO), the next target image is acquired from the storage unit 206 (Step S501), and the processing of Step S502 is executed for the next target image.

On the other hand, if there are no more target images to process (Step S504: NO), that is, if the image analysis target image extraction processing is executed for all images stored in the storage unit 206 (Steps S501 to S503), the image analysis target image extraction processing is ended.

By executing the image analysis target image extraction processing as described above, a subset table (see, for example, FIG. 9B) including images necessary for image analysis is created.

Next, returning to FIG. 5, the description is continued.

When the image analysis target image extraction processing (Step S13) is ended, secure computation necessity determination processing and image decryption processing are executed next (Step S14, S15).

First, the secure computation necessity determination processing (Step S14) will be described.

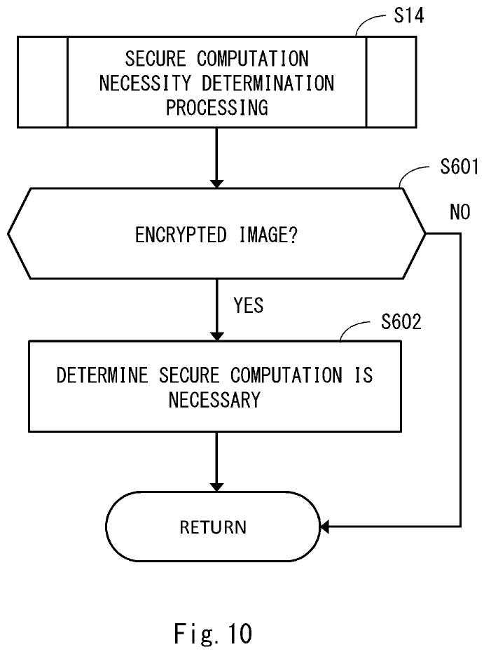

FIG. 10 is a flowchart of the secure computation necessity determination processing (Step S14). The processing shown in FIG. 10 is performed, for example, by the secure computation determination unit 233. The secure computation determination unit 233 is an example of secure computation necessity determination means according to the present disclosure.

A target of the secure computation necessity determination processing is all images (all images included in the subset table) extracted in the image analysis target image extraction processing (Step S13). Hereinafter, these images are referred to as target images.

The following Steps S601 to S602 are executed (one by one) for each target image.

First, it is determined whether or not the target image is an encrypted image (Step S601).

If it is determined that the target image is not an encrypted image as a result of the determination in Step S601 (Step S601: No), the secure computation necessity determination processing is ended.

On the other hand, if it is determined that the target image is an encrypted image as a result of the determination in Step S601 (Step S601: Yes), the target image is determined to require secure computation (Step S602). The determination result is saved, for example, as meta information of the target image (image file) or as metadata of the subset table.

Next, the image decryption processing (Step S15) will be described.

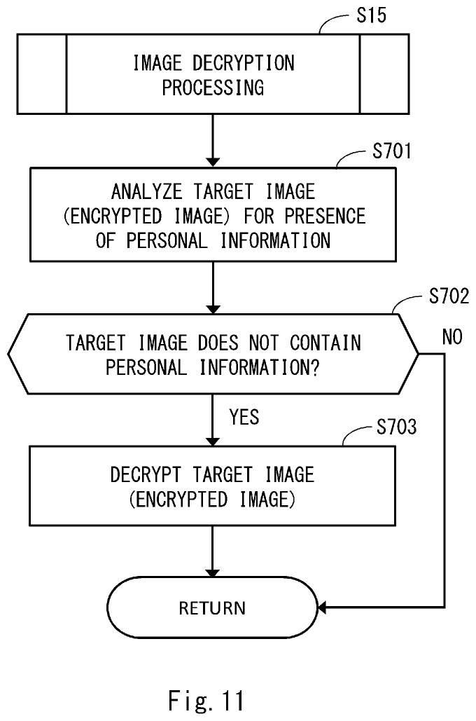

FIG. 11 is a flowchart of the image decryption processing (Step S15).

A target of the image decryption processing is all encrypted images extracted in the image analysis target image extraction processing (Step S13). Hereinafter, these images are referred to as target images.

Steps S701 to S703 below are executed (one by one) for each target image.

First, the target image (e.g., encrypted image included in the subset table) is analyzed for the presence of personal information using secure computation (Step S701). This is performed, for example, by the personal information analysis unit 203. By conducting this analysis using secure computation without decryption, even if the image were to leak or be exposed from the image analysis system 1, the personal information contained within that image remains encrypted, thereby reducing the risk of personal information leakage. In other words, security measures can be taken against leaks.

Next, it is determined whether or not the target image contains personal information (Step S702). This is performed, for example, by the personal information analysis unit 203.

If it is determined that the personal information is included as a result of the determination in Step S702 (Step S702: No), the image decryption processing is ended.

On the other hand, if it is determined that the personal information is not included as a result of the determination in Step S702 (Step S702: Yes), the target image (encrypted image) is decrypted (Step S703). This is done, for example, by the image file decryption unit 232.

This decryption is performed, for example, in the following cases. (1) At the time of storage of an image in the storage unit 206, the image has been encrypted, but through various processing when the subset table was being created, it became an image in which individuals cannot be identified. (2) When the personal information that has been encrypted in the image analysis system has been changed.

Next, returning to FIG. 5, the description is continued.

When there is a next target image (YES in Step S16), meaning that the secure computation necessity determination processing (Step S14) and image decryption processing (Step S15) have not been performed for all the images extracted by the image analysis target image extraction processing (Step S13), the secure computation necessity determination processing (Step S14) and the image decryption processing (Step S15) are executed for the next target image.

On the other hand, when there is no next target image (YES in Step S16), that is, when the secure computation necessity determination processing (Step S14) and the image decryption processing (Step S15) have been executed for all images extracted in the image analysis target image extraction processing (Step S13), the secure computation necessity determination processing (Step S14) and the image decryption processing (Step S15) are ended.

By decrypting as described above, the load of secure computation (image analysis using secure computation) in the image analysis processing can be reduced.

Next, the image analysis processing is performed (Step S17). This is performed, for example, by the image analysis unit 204 based on a result of the secure computation necessity determination processing.

The image analysis processing (Step S17) will now be described.

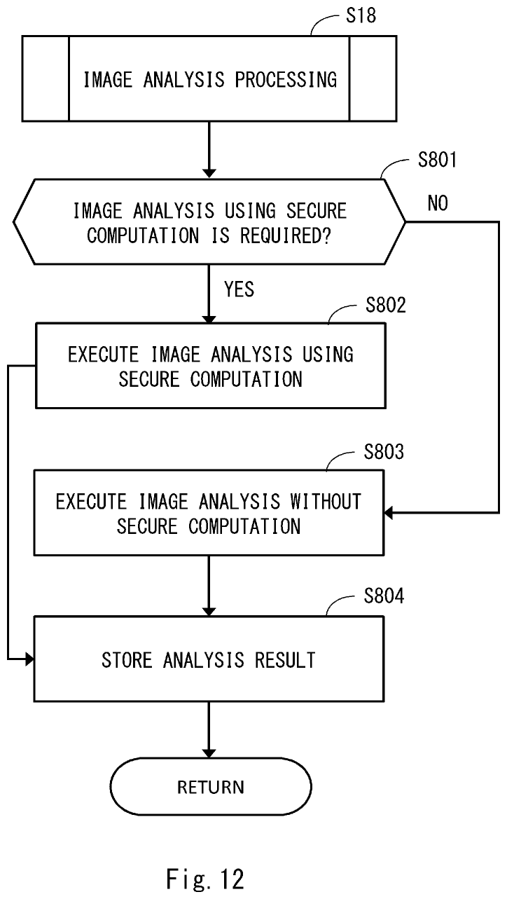

FIG. 12 is a flowchart of the image analysis processing (Step S17). The processing shown in FIG. 12 is executed, for example, by the image analysis unit 204. The image analysis unit 204 is an example of the image analysis means according to the present disclosure.

A target of the image analysis processing is all images (all images included in the subset table) extracted in the image analysis target image extraction processing (Step S13). Hereinafter, these images are referred to as target images.

Steps S801 to S804 below are executed (one by one) for each target image.

First, for each target image, it is determined whether or not the target image requires image analysis using secure computation (Step S801). This is determined based on a result of the secure computation necessity determination processing.

Next, if the result of the determination in Step S801 indicates that image analysis using secure computation is necessary (Step S801: Yes), image analysis using secure computation is executed for the target image determined to require secure computation (Step S802). This image analysis is performed using the method of image analysis received in Step S10.

On the other hand, if the result of the determination in Step S801 indicates that image analysis using secure computation is not necessary (Step S801: No), image analysis without the use of secure computation is executed for the target image determined not to require secure computation (Step S803). This image analysis is performed using the method of image analysis received in Step S10.

The image analysis executed in Step S802 is the same as the image analysis executed in Step S803. However, the image analysis executed in Step S802 uses secure computation, whereas the image analysis carried out in Step S803 does not use secure computation. Therefore, the image analysis in Step S802 differs from the image analysis in Step S803 in terms of accuracy and the time required for image analysis (typically, image analysis using secure computation takes longer than image analysis without secure computation).

The result of the image analysis executed in Step S802 and the result of the image analysis executed in Step S803 are stored in the storage unit 206 (Step S804).

The image analysis unit 204 stores analysis result data generated by the image analysis in the storage unit 206. The analysis result data includes, for example, various feature quantities extracted from each image.

Furthermore, the image analysis unit 204 may store the calculation results obtained through various processing such as aggregation and editing based on the analysis result data in the storage unit 206. For example, the image analysis unit 204 may group a plurality of feature quantities extracted from a plurality of images (e.g., a plurality of frames from a moving image) that are similar to each other and store information indicating the results of this grouping in the storage unit 206. Through such grouping, it is possible to group feature quantities of the same person (such as facial features) extracted from a plurality of images, group feature quantities of similar poses extracted from the plurality of images, or group feature quantities of the same vehicle model extracted from the plurality of images.

Next, returning to FIG. 5, the description is continued.

When the image analysis processing (Step S17) is ended, analysis report output processing is executed next (Step S18).

The analysis report output processing (Step S18) will now be described.

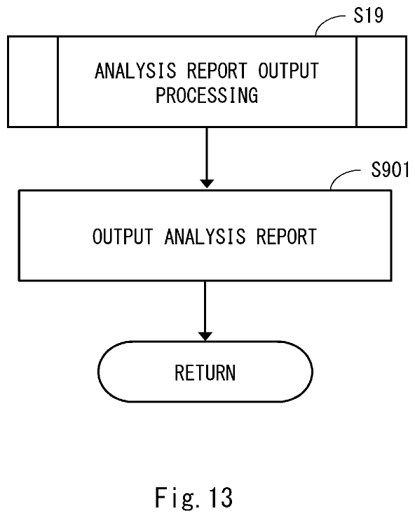

FIG. 13 is a flowchart of the analysis report output processing (Step S18).

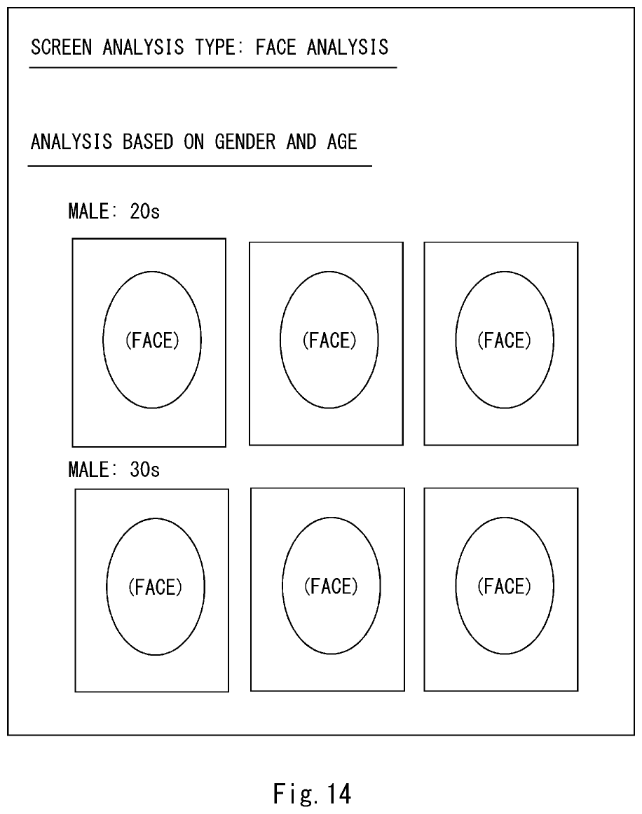

As shown in FIG. 13, the analysis report output processing is the process of outputting the analysis report (result of image analysis processing) (Step S901). This is performed, for example, by the output unit 205. FIG. 14 shows an example of the analysis report.

As described above, according to the second example embodiment, measures (security measures) can be taken to prevent the leakage of image analysis target images (images containing personal information such as names, phone numbers, and photos that can identify individuals).

This is achieved by encrypting the image analysis target image if it is determined that the image analysis target image contains personal information (Step S401: Yes). By encrypting images containing personal information in this way (Step S402), the risk of personal information leakage is reduced, even if the image were to leak or be exposed from the image analysis system 1 (image analysis server 200). In other words, security measures can be taken against leaks.

According to the second example embodiment, by encrypting still image files containing personal information, the risk of leakage of personal information contained in still images can be reduced. Similarly, by encrypting moving image files containing personal information, the risk of leakage of personal information contained in moving images can be reduced.

Furthermore, according to the second embodiment, because the user selects personal information and encrypts the image analysis target image containing the selected personal information (Step S402), without encrypting an image analysis target image that does not contain the selected personal information, it allows the image analysis server 200 to have more flexibility compared to encrypting all image analysis target images containing all personal information it holds. This provides greater flexibility to the image analysis system 1 (image analysis server 200).

Furthermore, according to the second embodiment, by encrypting an image containing personal information and performing image analysis using secure computation, it is possible to reduce the risk associated with personal information leakage. In other words, because image analysis is performed using secure computation on encrypted images, encrypted images containing personal information are not decrypted during the image analysis. Additionally, even if a leak occurs due to some factor, the leaked images are either images that do not contain personal information or encrypted images, so there is no risk of personal information leakage, and the associated risk can be minimized.

Furthermore, according to the second embodiment, when an encrypted image that does not contain personal information is generated after various processing or when personal information to be encrypted in the image analysis system is changed, unnecessary secure computation can be reduced by decrypting the encrypted image that does not contain personal information. Additionally, by using secure computation at the stage of the determination processing without decryption, it is possible to reduce the risk of personal information leakage from the decrypted data.

Next, a modified example will be described.

In the above second example embodiment, an example of performing image analysis has been described, but the present disclosure is not limited thereto. For example, it is also possible to perform encryption of specific personal information within an image file by designating the image file and the personal information to be analyzed without conducting image analysis.

In the first and second example embodiments, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Read Only Memory), CD-R, CD-R/W, DVD (Digital Versatile Disc), and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The numerical values shown in the above-described embodiments are all illustrative, and it is, of course, possible to use different appropriate numerical values.

The above example embodiments are mere examples in all respects. The description of the above example embodiments should not be construed as limiting the present disclosure. The present disclosure can be implemented in various other ways without departing from its spirit or essential features.

### REFERENCE SIGNS LIST

1 . . . IMAGE ANALYSIS SYSTEM
100 . . . USER TERMINAL
110 . . . CONTROL UNIT
111 . . . MEMORY
112 . . . STORAGE APPARATUS
113 . . . COMMUNICATION UNIT
200 . . . IMAGE ANALYSIS SERVER
201 . . . INPUT UNIT
202 . . . IMAGE DESIGNATION UNIT
203 . . . PERSONAL INFORMATION ANALYSIS UNIT
204 . . . IMAGE ANALYSIS UNIT
205 . . . OUTPUT UNIT
206 . . . STORAGE UNIT
210 . . . CONTROL UNIT
211 . . . MEMORY
212 . . . STORAGE APPARATUS
213 . . . COMMUNICATION UNIT
231 . . . IMAGE FILE ENCRYPTION UNIT
232 . . . IMAGE FILE DECRYPTION UNIT
233 . . . SECURE COMPUTATION DETERMINATION UNIT
300 . . . PERSONAL INFORMATION ANALYSIS MEANS
301 . . . ENCRYPTION MEANS
302 . . . STORAGE MEANS

What is claimed is:

1. An image analysis server comprising:
at least one memory storing instructions, and
at least one processor configured to execute the instructions to;
determine whether an image analysis target image contains personal information;
encrypt the image analysis target image if it is determined that the image analysis target image contains the personal information; and
store the image analysis target image encrypted by the encryption means.

2. The image analysis server according to claim 1, wherein the image analysis target image is a still image or a moving image.

3. The image analysis server according to claim 1, wherein the at least one processor is further configured to execute the instructions to;
receive personal information selected by a user,
determine whether the image analysis target image contains the personal information selected by the user.

4. The image analysis server according to claim 1,
wherein the at least one processor is further configured to execute the instructions to;
determine whether the image analysis target image stored requires image analysis using secure computation;
perform image analysis using secure computation on an image determined to require image analysis using the secure computation.

5. The image analysis server according to claim 1, wherein the at least one processor is further configured to execute the instructions to;
determine whether the encrypted image analysis target image stored contains personal information, and
decrypt an image determined not to contain the personal information.

6. An image analysis system comprising:
at least one memory storing instructions, and
at least one processor configured to execute the instructions to;
determine whether an image analysis target image contains personal information;
encrypt the image analysis target image if it is determined that the image analysis target image contains the personal information; and
store the image analysis target image encrypted by the encryption means.

7. The image analysis system according to claim 6, wherein the image analysis target image is a still image or a moving image.

8. An image analysis method comprising:
determining whether an image analysis target image contains personal information;
encrypting the image analysis target image if it is determined that the image analysis target image contains the personal information; and
storing the image analysis target image encrypted.

9. The image analysis method according to claim 8, wherein the image analysis target image is a still image or a moving image.

10. A non-transitory computer readable medium storing a program for causing a computer to execute:
determining whether an image analysis target image contains personal information;
encrypting the image analysis target image if it is determined that the image analysis target image contains the personal information; and
storing the image analysis target image encrypted.
